(19) United States
(12) Patent Application Publication
(10) Pub. No.: US 2017/0080933 A1
(43) Pub. Date: Mar. 23, 2017

(54) SYSTEM AND METHOD FOR CONTROLLING DRIVING OF AUTONOMOUS VEHICLE

(71) Applicant: HYUNDAI MOTOR COMPANY, Seoul (KR)

(72) Inventors: Won Jin JO, Hwaseong-Si (KR); Hyoung Geun KWON, Seongnam-Si (KR); Tae Won LIM, Seoul (KR); Yoonho JANG, Seoul (KR); Byungyong YOU, Suwon-si (KR)

(21) Appl. No.: 14/944,799

(22) Filed: Nov. 18, 2015

(30) Foreign Application Priority Data
Sep. 21, 2015 (KR) 10-2015-0133343

(51) Int. Cl. B60W 30/14; B60W 10/04; B60W 10/10; G05D 1/02

(52) U.S. Cl. CPC B60W 30/143; G05D 1/0274; G05D 1/0223; B60W 10/04; B60W 10/10; B60W 2710/1005; B60W 2720/10; B60W 2520/10; G01S 19/13

(57) ABSTRACT

A method and system for controlling driving of an autonomous vehicle by: (a) determining whether the autonomous vehicle is performing unmanned driving; (b) setting a maximum threshold speed, a minimum threshold speed, and a fuel efficient driving section when the autonomous vehicle determined to be performing unmanned driving; (c) determining whether the autonomous vehicle is driving in the fuel efficient driving section; (d) comparing a vehicle speed with the maximum threshold speed and the minimum threshold speed when the autonomous vehicle is driving in the fuel efficient driving section; (e) controlling the autonomous vehicle to accelerate when the vehicle speed is less than the minimum threshold speed; (f) controlling the autonomous vehicle to coast when the vehicle speed is greater than or equal to the maximum threshold speed; and (g) repeating the steps (e) to (f) while the autonomous vehicle is driving in the fuel efficient driving section.

### CROSS-REFERENCE TO RELATED APPLICATION

This application claims the benefit of priority to Korean Patent Application No. 10-2015-0133343, filed in the Korean Intellectual Property Office on Sep. 21, 2015, the entire contents of which are incorporated herein by reference.

### BACKGROUND

(a) Field

The present disclosure relates to a system and a method for controlling driving of an autonomous vehicle. More particularly, the disclosure relates to a system and a method for controlling driving of an autonomous vehicle that repeatedly performs, selectively, acceleration control and coasting control when the autonomous vehicle is performing unmanned driving.

(b) Description of the Related Art

In general, an autonomous vehicle is a vehicle that is capable of monitoring external information, recognizing a road situation, and autonomously travelling to a set destination without manipulation of a vehicle owner.

The autonomous vehicle maintains a constant engine speed and vehicle speed, so ride comfort of a driver can be improved and NVH (noise, vibration, and harshness) performance can be reduced. However, a conventional method for controlling driving of the autonomous vehicle controls the autonomous vehicle at a driving region where fuel efficiency is low in order to maintain the engine speed and the vehicle speed.

The number of autonomous vehicles being driven while unmanned has increased as vehicle technology has been recently developed. Therefore, when an autonomous vehicle is driven while unmanned, the ride comfort or the NVH cannot be considered, and thus a new method for enhancement of fuel efficiency is needed.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a system and a method for controlling driving of an autonomous vehicle having advantages of improving fuel efficiency of the autonomous vehicle by repeatedly performing acceleration control and coasting control when the autonomous vehicle is performing unmanned driving.

An exemplary embodiment of the present invention provides a method for controlling driving of an autonomous vehicle that may include: (a) determining whether the autonomous vehicle is performing unmanned driving; (b) setting a maximum threshold speed, a minimum threshold speed, and a fuel efficient driving section when the autonomous vehicle is performing unmanned driving; (c) determining whether the autonomous vehicle is driving in the fuel efficient driving section; (d) comparing a vehicle speed with the maximum threshold speed and the minimum threshold speed when the autonomous vehicle is driving in the fuel efficient driving section; (e) controlling the autonomous vehicle to accelerate when the vehicle speed is less than the minimum threshold speed; (f) controlling the autonomous vehicle to coast when the vehicle speed is greater than or equal to the maximum threshold speed; and (g) repeating the steps (e) to (f) while the autonomous vehicle is driving in the fuel efficient driving section.

The method may further include controlling the autonomous vehicle to maintain an engine speed and the vehicle speed when the autonomous vehicle is not performing unmanned driving in step (a).

The method may further include controlling the autonomous vehicle to maintain the engine speed and the vehicle speed when the autonomous vehicle is not driving in the fuel efficient driving section in step (c).

The maximum threshold speed, the minimum threshold speed, and the fuel efficient driving section may be set based on road information in the step (b).

A difference value between the maximum threshold speed and the minimum threshold speed in step (b) may be greater than or equal to a predetermined speed.

The step (e) may set a position value of an accelerator pedal as a predetermined value.

The step (f) may set the position value of the accelerator pedal as 0% and shift to a neutral position.

Another exemplary embodiment of the present invention provides a system for controlling driving of an autonomous vehicle that may include: a data detector configured to detect data for determining whether the autonomous vehicle is performing unmanned driving and a location of the autonomous vehicle; a navigation device configured to output road information according to the location of the autonomous vehicle; and a controller configured to determine whether the autonomous vehicle is performing unmanned driving based on signals from the data detector and the navigation device, set a maximum threshold speed, a minimum threshold speed, and a fuel efficient driving section when the autonomous vehicle is performing unmanned driving, and repeatedly perform acceleration control and coasting control by comparing vehicle speed with the maximum threshold speed and the minimum threshold speed when the autonomous vehicle is driving in the fuel efficient driving section.

The controller may control the autonomous vehicle to accelerate when the vehicle speed is less than the minimum threshold speed and control the autonomous vehicle to coast when the vehicle speed is greater than or equal to the maximum threshold speed.

The controller may control the autonomous vehicle to accelerate by setting a position value of an accelerator pedal as a predetermined value.

The controller may control the autonomous vehicle to coast by setting the position value of the accelerator pedal as 0% and shifting to a neutral position.

The controller may control the autonomous vehicle to maintain an engine speed and the vehicle speed when the autonomous vehicle is not performing unmanned driving.

The controller may control the autonomous vehicle to maintain the engine speed and the vehicle speed when the autonomous vehicle is not driving in the fuel efficient driving section.

The controller may set the maximum threshold speed, the minimum threshold speed, and the fuel efficient driving section based on road information output from the navigation device.

The controller may set a difference value between the maximum threshold speed and the minimum threshold speed to be greater than or equal to a predetermined speed.

As described above, according to an exemplary embodiment of the present invention, fuel efficiency of the autonomous vehicle can be improved by controlling the autonomous vehicle driving at a high fuel efficiency region.

### BRIEF DESCRIPTION OF THE DRAWINGS

FIG. 1 is a schematic block diagram showing a system for controlling driving of an autonomous vehicle according to an exemplary embodiment of the present invention.

FIG. 2 is a flowchart showing a method for controlling driving of an autonomous vehicle according to an exemplary embodiment of the present invention.

FIG. 3 is drawing in which a driving region according to an exemplary embodiment of the present invention and a driving region according to a conventional art are compared.

FIG. 4 is graph showing a change of a vehicle speed according to a method for controlling driving of an autonomous vehicle according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Throughout this specification and the claims which follow, unless explicitly described to the contrary, the word “comprise” and variations such as “comprises” or “comprising” will be understood to imply the inclusion of stated elements but not the exclusion of any other elements.

Like reference numerals designate like elements throughout the specification.

It is understood that the term “vehicle” or “vehicular” or other similar term as used herein is inclusive of motor vehicles in general including hybrid vehicles, plug-in hybrid electric vehicles, and other alternative fuel vehicles (e.g., fuels derived from resources other than petroleum). As referred to herein, a hybrid electric vehicle is a vehicle that has two or more sources of power, for example both gasoline-powered and electric-powered vehicles.

Additionally, it is understood that some of the methods may be executed by at least one controller. The term controller refers to a hardware device that includes a memory and a processor configured to execute one or more steps that should be interpreted as its algorithmic structure. The memory is configured to store algorithmic steps and the processor is specifically configured to execute said algorithmic steps to perform one or more processes which are described further below.

Furthermore, the control logic of the present invention may be embodied as non-transitory computer readable media on a computer readable medium containing executable program instructions executed by a processor, a controller, or the like. Examples of computer readable media include, but are not limited to, ROM, RAM, compact disc (CD)-ROMs, magnetic tapes, floppy disks, flash drives, smart cards, and optical data storage devices. The computer readable recording medium can also be distributed in network coupled computer systems so that the computer readable media are stored and executed in a distributed fashion, e.g., by a telematics server or a controller area network (CAN).

An exemplary embodiment of the present invention will hereinafter be described in detail with reference to the accompanying drawings.

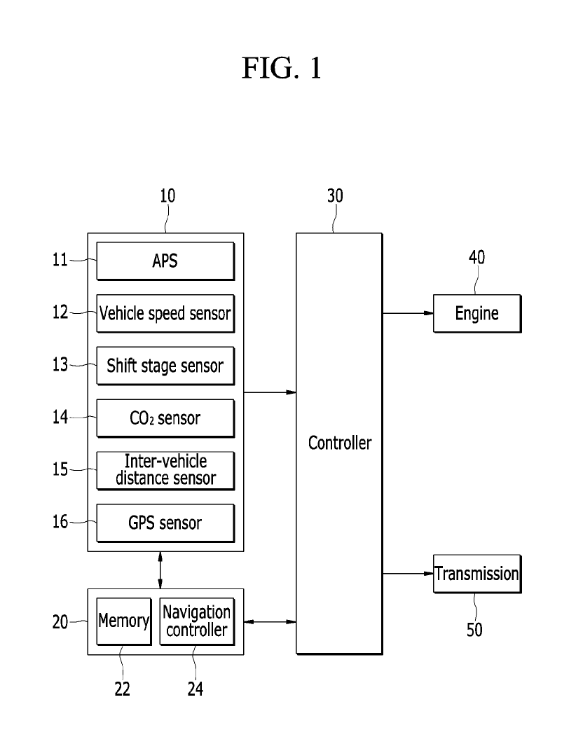

FIG. 1 is a schematic block diagram showing a system for controlling driving of an autonomous vehicle according to an exemplary embodiment of the present invention.

As shown in FIG. 1, a system for controlling driving of an autonomous vehicle according to an exemplary embodiment of the present invention includes a data detector 10, a navigation device 20, a controller 30, an engine 40, and a transmission 50.

Hereinafter, constituent elements will be sequentially described.

The data detector 10 detects data for determining whether the autonomous vehicle is performing unmanned driving and determining a location of the autonomous vehicle, and the data is transmitted to the controller 30. The data detector 10 includes an accelerator pedal position sensor 11, a vehicle speed sensor 12, a shift stage sensor 13, a carbon dioxide (CO₂) sensor 14, an inter-vehicle distance sensor 15, and a global position system (GPS) sensor 16.

The accelerator pedal position sensor 11 detects a degree at which a driver pushes an accelerator pedal. The position value of the accelerator pedal may be 100% when the accelerator pedal is pressed fully, and 0% when the accelerator pedal is not pressed at all.

The vehicle speed sensor 12 detects a vehicle speed, and is mounted at a wheel of the vehicle. Alternatively, the vehicle speed may be calculated based on a signal received by the GPS sensor 16.

Meanwhile, a target shift stage may be calculated by using a shift pattern based on the signal of the accelerator pedal position sensor 11 and the signal of the vehicle speed sensor 12, and the shift to the target shift stage is thereby controlled.

The shift stage sensor 13 detects a shift stage that is currently engaged.

The carbon dioxide (CO₂) sensor 14 detects a carbon dioxide concentration in the vehicle. The controller 20 may determine whether a passenger exists in the autonomous vehicle through the carbon dioxide sensor 14. A piezoelectric sensor instead of the carbon dioxide sensor 14 may be used to determine whether a passenger exists.

The inter-vehicle distance sensor 15 detects an inter-vehicle distance between the vehicle and a preceding vehicle. Various sensors such as an ultrasonic wave sensor and an infrared sensor may be used as the inter-vehicle distance sensor 15.

The global position system (GPS) sensor 16 is a sensor for acquiring a location of the vehicle. According to current technologies, the GPS sensor 18 may calculate information regarding distances from three or more satellites and time information, and apply trigonometry to the calculated information to accurately calculate 3D current location information based on the latitude, the longitude, and the altitude. A method of calculating location and time information by using three satellites and correcting an error of the calculated location and time information by using a single satellite is commonly used. Also, the GPS sensor 16 may calculate information regarding the speed of a vehicle by continuously calculating a current location of the vehicle in real time.

The navigation device 20 is a device providing to the driver information regarding a route to a destination. The navigation device 20 may include a memory 22 storing compressed information regarding forward roads and a navigation controller 24 performing general control of the navigation device 20.

In addition, the navigation device 20 includes a wireless communication unit (not shown). The wireless communication unit may include one or more modules allowing for wireless communication between the navigation device 20 and a wireless communication system or between the navigation device 20 and a network in which the navigation device 20 is located.

The navigation device 20 may receive from the data detector 10 information regarding the vehicle. The navigation device 20 may output road information according to a location of the vehicle by using the information received from the data detector 10 at predetermined time intervals.

The navigation device 20 described herein may include a cellular phone, a smartphone, a laptop computer, a digital broadcast terminal, a personal digital assistant (PDA), a portable multimedia player (PMP), and the like.

The memory 22 may store a program for processing and controlling the navigation controller 24, or may serve to temporarily store input/output data (e.g., data detected by the data detector 10, map data of the navigation device 20, or the like). The memory 22 may store use frequency of each data.

The memory 22 may include at least one type of storage medium among a flash memory type, a hard disk type, a multimedia card micro type, a card type memory (e.g., SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The apparatus for processing road information may operate in relation to Web storage performing a storage function of the memory 22 on the Internet.

The controller 30 may control the engine 40 or the transmission 50 based on signals output from the data detector 10 and the navigation device 20.

The controller 30 determines whether the autonomous vehicle is performing unmanned driving based on signals from the data detector and the navigation device, sets a maximum threshold speed, a minimum threshold speed, and a fuel efficient driving section while the autonomous vehicle is performing unmanned driving, and repeatedly performs acceleration control and coasting control by comparing a vehicle speed with the maximum threshold speed and the minimum threshold speed while the autonomous vehicle is driving in the fuel efficient driving section.

That is, the controller 30 may control the autonomous vehicle to accelerate while the vehicle speed is less than the minimum threshold speed and may control the autonomous vehicle to coast while the vehicle speed is greater than or equal to the maximum threshold speed.

For these purposes, the controller 30 may be implemented as at least one processor that is operated by a predetermined program, and the predetermined program may be programmed in order to perform each step of a method for controlling driving of an autonomous vehicle according to an exemplary of the present invention.

Various embodiments described herein may be implemented within a recording medium that may be read by a computer or a similar device by using software, hardware, or a combination thereof, for example.

According to hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electric units designed to perform any other functions.

According to software implementation, embodiments such as procedures and functions described in the present embodiments may be implemented by separate software modules. Each of the software modules may perform one or more functions and operations described in the present invention. A software code may be implemented by a software application written in an appropriate program language.

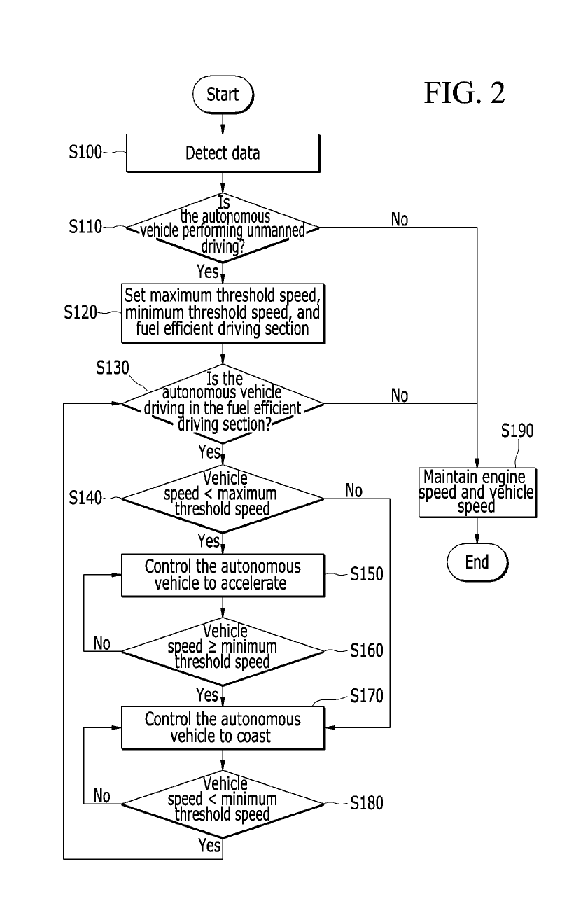

Hereinafter, a method for controlling driving of an autonomous vehicle according to an exemplary embodiment of the present invention will be described in detail with reference to FIG. 2 to FIG. 4.

FIG. 2 is a flowchart showing a method for controlling driving of an autonomous vehicle according to an exemplary embodiment of the present invention.

As shown in FIG. 2, a method for controlling driving of an autonomous vehicle according to an exemplary embodiment of the present invention starts with detecting data by the data detector 10 at step S100.

When the data is detected at the step S100, the controller 30 determines whether the autonomous vehicle is performing unmanned driving based on the data at step S110.

When the autonomous vehicle is performing unmanned driving at the step S110, the controller 30 sets a maximum threshold speed, a minimum threshold speed, and a fuel efficient driving section at step S120.

The controller 30 may first set the fuel efficient driving section. That is, the controller 30 may determine a current location of the autonomous vehicle by receiving a GPS signal from the data detector 10, and set the fuel efficient driving section according to a path for a predetermined destination based on road information output from the navigation device 20. For example, if the autonomous vehicle is performing unmanned driving a distance of 50 km between the current location of the autonomous vehicle and the predetermined destination, a section of 30 km which is a highway according to the road information may be set as the fuel efficient driving section.

When the fuel efficient driving section is set as described above, the controller 30 may set the maximum threshold speed and the minimum threshold speed. Herein, the maximum threshold speed may be set as a speed limit according to the road information, and the minimum threshold speed may be set as a value found by subtracting a predetermined speed according to a fuel consumption map from the maximum threshold speed. For example, If the speed limit is 80 km/h in the fuel efficient driving section, the maximum threshold speed may be set as 80 km/h, and the predetermined speed according to the fuel consumption map may be 20 km/h such that the minimum threshold speed may be set as 60 km/h.

On the other hand, when the autonomous vehicle is not performing unmanned driving at step S110, the controller 30 controls the autonomous vehicle to steadily run at step S190. That is, the controller 30 maintains an engine speed and a vehicle speed of the autonomous vehicle.

When the maximum threshold speed, the minimum threshold speed, and the fuel efficient driving section are set at step S120, the controller 30 determines whether the autonomous vehicle is driving in the fuel efficient driving section at step S130.

When the autonomous vehicle is driving in the fuel efficient driving section at step S130, the controller 30 compares the vehicle speed with the maximum threshold speed and the minimum threshold speed at step S140.

On the other hand, when the autonomous vehicle is not driving in the fuel efficient driving section at step S130, the controller 30 maintains the engine speed and the vehicle speed of the autonomous vehicle to steadily run.

When the vehicle speed is less than the minimum threshold speed at step S140, the controller 30 controls the autonomous vehicle to accelerate at step S150.

Herein, the controller 30 may control the autonomous vehicle to accelerate by setting a position value of an accelerator pedal as a predetermined value until the vehicle speed reaches the maximum threshold speed. The predetermined value may randomly set as any one value among 70% to 80% according to the fuel consumption map.

After that, the vehicle speed of the autonomous vehicle reaches the maximum threshold speed at step S160, the controller 30 controls the autonomous vehicle to coast at step S170.

Herein, the controller 30 may control the autonomous vehicle to coast by setting the position value of the accelerator pedal as 0% and shifting to a neutral position until the vehicle speed reaches minimum threshold speed.

Meanwhile, if the vehicle speed is greater than or equal to the maximum threshold speed at a moment when the autonomous vehicle enters the fuel efficient driving section at step S140, the controller 30 proceeds to step S170 and controls the autonomous vehicle to coast.

After that, when the vehicle speed becomes less than the minimum threshold speed at step S180, the controller 30 returns the process to step S130. That is, the controller 30 repeatedly performs the acceleration control at step S150 and the coasting control at step S170 by comparing the vehicle speed with the maximum threshold speed and the minimum threshold speed.

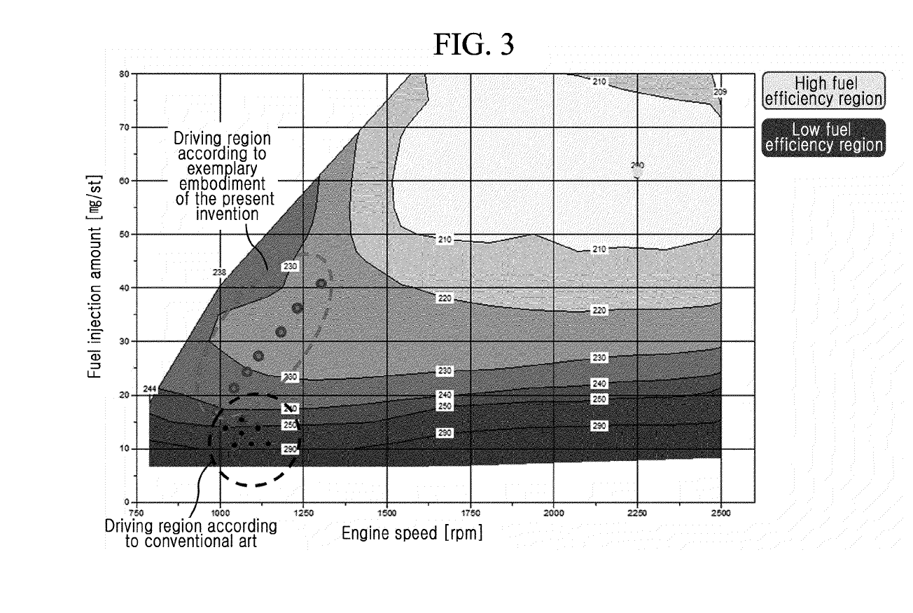

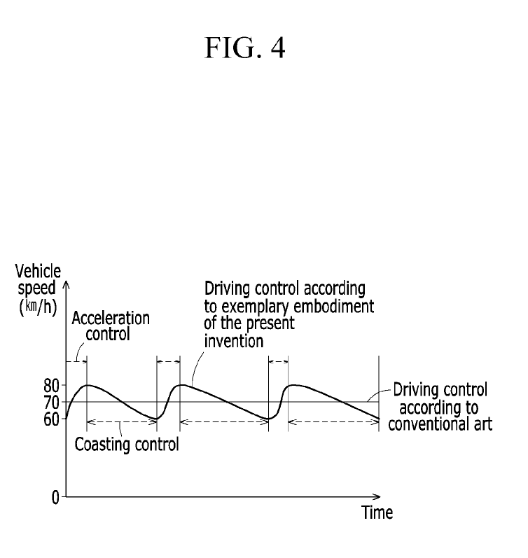

FIG. 3 is drawing in which a driving region according to an exemplary embodiment of the present invention and a driving region according to a conventional art are compared, and FIG. 4 is graph showing a change of a vehicle speed according to a method for controlling driving of an autonomous vehicle according to an exemplary embodiment of the present invention. For example, the maximum threshold speed is 80 km/h and the minimum threshold speed is 60 km/h in FIG. 4.

As shown in FIG. 3, according to a conventional art, the autonomous vehicle is controlled at a driving region where fuel efficiency is low to maintain the engine speed and the vehicle speed. Therefore, as shown in FIG. 4, the autonomous vehicle according to the conventional art may maintain the vehicle speed as 70 km/h.

However, as shown in FIG. 4, the autonomous vehicle according to an exemplary embodiment of the present invention repeatedly performs acceleration control and coasting control between the maximum threshold speed and the minimum threshold speed. Therefore, as shown in FIG. 3, the autonomous vehicle can be controlled at a driving region where fuel efficiency is high.

As described above, according to an exemplary embodiment of the present invention, the autonomous vehicle can be controlled and shifting friction elements can be saved by shifting to a neutral position, thereby improving fuel efficiency.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A method for controlling driving of an autonomous vehicle, comprising:
(a) determining whether the autonomous vehicle is performing unmanned driving;
(b) setting a maximum threshold speed, a minimum threshold speed, and a fuel efficient driving section when the autonomous vehicle is determined to be performing unmanned driving;
(c) determining whether the autonomous vehicle is driving in the fuel efficient driving section;
(d) comparing a vehicle speed with the maximum threshold speed and the minimum threshold speed when the autonomous vehicle is determined to be driving in the fuel efficient driving section;
(e) controlling the autonomous vehicle to accelerate when the vehicle speed is less than the minimum threshold speed;
(f) controlling the autonomous vehicle to coast when the vehicle speed is greater than or equal to the maximum threshold speed; and
(g) repeating the steps (e) to (f) while the autonomous vehicle is driving in the fuel efficient driving section.

2. The method of claim 1, further comprising controlling the autonomous vehicle to maintain an engine speed and the vehicle speed when the autonomous vehicle is determined to be not performing unmanned driving in the step (a).

3. The method of claim 1, further comprising controlling the autonomous vehicle to maintain the engine speed and the vehicle speed when the autonomous vehicle is determined to be not driving in the fuel efficient driving section in the step (c).

4. The method of claim 1, wherein the maximum threshold speed, the minimum threshold speed, and the fuel efficient driving section are set based on road information in the step (b).

5. The method of claim 4, wherein a difference value between the maximum threshold speed and the minimum threshold speed in the step (b) is greater than or equal to a predetermined speed.

6. The method of claim 1, wherein the step (e) sets a position value of an accelerator pedal as a predetermined value.

7. The method of claim 1, wherein the step (f) sets the position value of the accelerator pedal as 0% and shifts to a neutral position.

8. A system for controlling driving of an autonomous vehicle, comprising:
a data detector configured to detect data for determining whether the autonomous vehicle is performing unmanned driving and determining a location of the autonomous vehicle;
a navigation device configured to output road information according to the location of the autonomous vehicle; and
a controller configured to determine whether the autonomous vehicle is performing unmanned driving based on signals from the data detector and the navigation device, set a maximum threshold speed, a minimum threshold speed, and a fuel efficient driving section when the autonomous vehicle is performing unmanned driving, and repeatedly perform acceleration control and coasting control by comparing a vehicle speed with the maximum threshold speed and the minimum threshold speed when the autonomous vehicle is determined to be driving in the fuel efficient driving section.

9. The system of claim 8, wherein the controller controls the autonomous vehicle to accelerate when the vehicle speed is less than the minimum threshold speed and controls the autonomous vehicle to coast when the vehicle speed is greater than or equal to the maximum threshold speed.

10. The system of claim 9, wherein the controller controls the autonomous vehicle to accelerate by setting a position value of an accelerator pedal as a predetermined value.

11. The system of claim 9, wherein the controller controls the autonomous vehicle to coast by setting the position value of the accelerator pedal as 0% and shifting to a neutral position.

12. The system of claim 8, wherein the controller controls the autonomous vehicle to maintain an engine speed and the vehicle speed when the autonomous vehicle is not performing unmanned driving.

13. The system of claim 8, wherein the controller controls the autonomous vehicle to maintain the engine speed and the vehicle speed when the autonomous vehicle is not driving in the fuel efficient driving section.

14. The system of claim 8, wherein the controller sets the maximum threshold speed, the minimum threshold speed, and the fuel efficient driving section based on road information output from the navigation device.

15. The system of claim 14, wherein the controller sets a difference value between the maximum threshold speed and the minimum threshold speed to be greater than or equal to a predetermined speed.
